(19) United States
(12) Patent Application Publication
(10) Pub. No.: US 2014/0058778 A1
(43) Pub. Date: Feb. 27, 2014

(54) LOCATION-AWARE CALENDARING

(71) Applicant: VMWARE, INC., Palo Alto, CA (US)

(72) Inventors: Melina MCLARTY, Palo Alto, CA (US); Muhammad Ahsen JAFFER, Palo Alto, CA (US); Andrey BELOKRYLOV, Palo Alto, CA (US)

(73) Assignee: VMware, Inc., Palo Alto, CA (US)

(21) Appl. No.: 13/873,666

(22) Filed: Apr. 30, 2013

Related U.S. Application Data
(60) Provisional application No. 61/693,173, filed on Aug. 24, 2012.

(51) Int. Cl. G06Q 10/10

(52) U.S. Cl. CPC G06Q 10/1095
USPC 705/7.19

(57) ABSTRACT

A location-aware calendaring system schedules a meeting after receiving a request from a meeting initiator interacting with a device, wherein the request identifies at least a meeting attendee. The system determines a location of the meeting initiator based on wireless signal strength information and a location of the meeting attendee, and then determines a meeting location based on the meeting request and at least the determined location of the meeting initiator and the determined location of the meeting attendee.

### CROSS-REFERENCE TO RELATED APPLICATION

This application claims benefit of U.S. Provisional Patent Application Ser. No. 61/693,173 filed Aug. 24, 2012, which is incorporated herein by reference in its entirety.

### BACKGROUND

Scheduling meetings frequently takes substantial time and effort, frustrating employees and affecting productivity. Two challenges to organizing a meeting include finding the most convenient meeting place for the attendees and then navigating to that location. The first part is cumbersome because an organizer has to determine, prior to reserving a meeting room for a particular time, the resources available in the meeting room, the availability of the meeting room, and that the location of the meeting room would be convenient for all attendees. The second part is not trivial, because employees may not be familiar with the plan of a campus and its buildings, or the location of the meeting room based only on the room name or other local designation.

At the same time, meetings are intended to be a tool employees use to solve corporate and project-related problems. Meetings are an integral part of a company's success and many employees has multiple meetings on a daily basis. However, as noted above, organizing meetings can be difficult. Selecting the proper meeting room becomes more troublesome if an individual is in a rush to book a meeting room or when a meeting is to be held in a building that is new or large to the attendees. Solving these problems would provide significant productivity gains for an organization.

### SUMMARY

Embodiments presented herein provide a location-aware calendaring system and method. The calendaring system schedules a meeting after receiving a request from a meeting initiator interacting with a device, wherein the request identifies at least a meeting attendee. The system determines a location of the meeting initiator based on wireless signal strength information and a location of the meeting attendee, and then determines a meeting location based on the meeting request and at least the determined location of the meeting initiator and the determined location of the meeting attendee.

### BRIEF DESCRIPTION OF THE DRAWINGS

FIG. 1 illustrates computing devices on a network in which one or more embodiments of the present invention can be implemented.

FIG. 2 illustrates a method is for scheduling an instant meeting, according to certain embodiments of the present invention.

FIG. 3 illustrates an example graphical user interface for generating an instant meeting in a calendaring tool, according to certain embodiments of the present invention.

FIG. 4 illustrates an example graphical user interface for generating an instant meeting on a mobile user interface, according to certain embodiments of the present invention.

FIG. 5 illustrates an example map of a floor of an office building, according to certain embodiments of the present invention.

FIG. 6 illustrates a method for the initial creation of spatial data for the locator map, according to certain embodiments of the invention.

FIG. 7 illustrates the typical office building Wireless routers calculated signal propagation, according to certain embodiments of the invention.

FIG. 8 illustrates the Wireless routers relationship between signal strength and distance to routers, according to certain embodiments of the invention.

FIG. 9 illustrates a method is building a neural network (NN) from calendar data, according to certain embodiments of the present invention.

For clarity, identical reference numbers have been used, where applicable, to designate identical elements that are common between figures. It is contemplated that features of one embodiment may be incorporated in other embodiments without further recitation.

### DETAILED DESCRIPTION

Embodiments of the invention provide techniques for building a location-aware calendaring system for scheduling meetings. In one embodiment, the location aware calendaring system provides a tool for generating an “instant meeting” for a meeting organizer. The calendaring tool provides the meeting organizer a set of preferences to aide in the selection of a meeting location, i.e., for the instant meeting. The preferences may include a meeting time, meeting location, necessary or preferred resources, as well as meeting attendees. After submitting the preferences for the meeting, the location aware calendaring system presents possible meeting room locations to the meeting organizer. The locations are based, at least in part, on the distance of the meeting rooms relative to detected locations for the attendees. The calendaring system provides a meeting room location to a meeting organizer.

After the organizer selects a meeting room location, the location aware calendaring system uses a path finding algorithm to determine an optimal route to the meeting room from the current location of one or more attendees. In one embodiment, current locations for each attendee may be determined by analyzing Received Signal Strength Indications (RSSI) for wireless routers inside the building. The location aware calendaring system determines a route from the current location of an attendee to the meeting location on a map. The meeting request is forwarded to the attendees along with the map displaying the attendee's real-time or current location along with the route to the meeting room. The map is periodically updated with the current location information associated with the attendee. Depending on user privacy settings, an “instant meeting” may be used for making quick face-to-face connections. A meeting organizer may share his or her location with another person to arrange a face-to-face meeting. The location aware calendaring provides a route from one person to another.

Among other things, the location-aware calendaring provides booking, walking directions, travel time minimization, and conflict prediction. With booking, a meeting organizer may book meetings rooms nearest to that person's location. Further, in one embodiment, a user books a meeting room from a wireless or other network device (e.g., a Wi-Fi connected Smartphone). The system books the nearest room to the user's current location, saving the user time and improving productivity.

In one embodiment, the location aware calendaring tool provides directions to the meeting location, e.g., as a web-page rendered on a mobile display. Large workspaces can be difficult to navigate and an employee may waste considerable time trying to find specific meeting rooms or other meeting locations. Thus, the directions allow meeting attendees to navigate to a meeting room quickly while saving time that would otherwise have be spent lost inside the building.

Spatial Data may be used to minimize travel times for all attendees when booking meetings with the location aware calendar system. When booking a meeting room with a group of attendees, the spatial data can be used to locate an optimal meeting location for all attendees. The system may have a default location for each potential attendee and use this information to recommend meeting rooms that minimize travel times for all attendees. Doing so may reduce the time that meeting attendees spend traveling to and from meeting rooms and improve overall productivity.

Conflict predictors are provided for attendees who travel between meetings managed in the location aware calendaring system. Travel times can be significant when users are traveling between meetings in large workplaces. The system can estimate travel time between the meetings and warn users ahead of a scheduled calendar item. This will allow meeting attendees to better manage their time and avoid rushing between meetings, arriving late, or missing meetings entirely.

Global Positioning System (GPS) is commonly used outdoors to navigate users between buildings of a campus. However, the use of GPS technology is not always an option for finding a user's location inside a building, e.g., due to weak or non-existent signal strength indoors. Therefore, network wireless signals inside a building can be used for providing the location information instead. Office buildings typically have many wireless routers installed throughout the building. The wireless routers emit radio signals which transmit their Basic Service Set Identifiers (BSSID). A device, communicating wirelessly with the router, can measure a Received Signal Strength Indication (RSSI) to determine the distance of the device from the router. Knowing the distance from multiple routers, whose positions are also known, allows a device to determine its position relative to those routers. Therefore a coordinate system can be fashioned from the RSSI. However, to see the location of the devices on a map requires the map to understand the RSSI coordinate locations provided to the devices.

Real world coordinates locations are registered with a map, tying the coordinates to mapped locations. Real-world coordinates are typically represented in three dimensions through mathematical models or signal measurement. A map projection is any method of representing the surface of a sphere (world) or other three-dimensional body on a plane (map). A map projection provides a framework for defining the real world locations.

Often, map data is spatially accurate but not in a “known” or recognized spatial coordinate system. The map data is said to be in a local coordinate system or of unknown projection. However, local coordinate systems can be very useful and practical. An example of an “unknown” coordinate system would be a coordinate system built from the local router wireless routers broadcast radio signals received by a wireless device. A Received Signal Strength Indication (RSSI) is a measurement of the power of the router radio signal at a wireless receiving device. One factor that affects the RSSI, is the distance of the receiving device from a router. The RSSI decreases with distance on a logarithmic scale. Therefore a distance from the router can be determined by the RSSI and a local coordinate system may be established through trilateration of the RSSI information for nearby routers. Holding the router positions as known fixed points on a map, through scaling and rubber-sheeting, the RSSI coordinates generated from the routers can be overlaid an applied to the spatial data on the map. The floor plans may be projected by transforming the spatial data with the local router coordinate system information.

Georeferencing is the procedure for providing the RSSI coordinate information to the map. A georeferenced map allows other spatial information (coordinate data depicting people or device locations) to be displayed on the map in relative position to each other with spatial accuracy. As each piece of spatial information can be represented as a layer on the map, much like in a cake, layers may obfuscate other layers underneath it and may be turned on or off. The layers in the georeferenced map are separate or distinct spatial data and the map is said to consume this spatial data. Thus when a map is consuming spatial data from a variety of sources, such as combining the map information with radio signals (GPS or RSSI), the mapping application knows where to position the spatial data (i.e. the device) on the display in relation to other map data.

In one embodiment, the georeferenced map consumes spatial data for navigating attendees to a meeting room. The router locations, identified in the spatial data, assist in the registration of the georeferenced map to a local projection (The RSSI coordinate system). Floor plans are supplied to the location aware calendaring system to assist navigating through the interior of a building. A portable computing device measures the RSSI for individual routers in the building and determines the portable computing devices location on the georeferenced map using the RSSI coordinate data.

A neural network may be used to determine a user location along with the spatial data. The neural network based approach compensates for the fluctuations in the RSSIs. Fluctuations in the RSSIs may be due to interference of signal propagation through a building by walls, other signal generators, temperature, humidity, or other objects. The neural network improves the ability of the system to accurately predict the location of an individual based on a current measure of RSSI strengths from multiple routers.

In the following, reference is made to embodiments of the invention. However, it should be understood that the invention is not limited to specific described embodiments. Instead, any combination of the following features and elements, whether related to different embodiments or not, is contemplated to implement and practice the invention. Furthermore, although embodiments of the invention may achieve advantages over other possible solutions and/or over the prior art, whether or not a particular advantage is achieved by a given embodiment is not limiting of the invention. Thus, the following aspects, features, embodiments and advantages are merely illustrative and are not considered elements or limitations of the appended claims except where explicitly recited in a claim(s). Likewise, reference to “the invention” shall not be construed as a generalization of any inventive subject matter disclosed herein and shall not be considered to be an element or limitation of the appended claims except where explicitly recited in a claim(s).

As will be appreciated by one of ordinary skill in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may be referred to herein as a “circuit,” “module” or “system.” Furthermore, aspects of the present invention may take the form of a computer program product embodied in one or more computer readable medium(s) having computer readable program code embodied thereon.

Any combination of one or more computer readable medium(s) may be utilized for storing a program product which, when executed, is configured to perform method for scheduling a meeting. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, radio, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing.

Computer program code for carrying out operations for aspects of the present invention may be written in any combination of one or more programming languages, including an object oriented programming language such as JAVA™, SMALLTALK™, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

Embodiments of the invention may be provided to end users through a cloud computing infrastructure. Cloud computing refers to the provision of scalable computing resources as a service over a network. More formally, cloud computing may be defined as a computing capability that provides an abstraction between the computing resource and its underlying technical architecture (e.g., servers, storage, networks), enabling convenient, on-demand network access to a shared pool of configurable computing resources that can be rapidly provisioned and released with minimal management effort or service provider interaction. Thus, cloud computing allows a user to access virtual computing resources (e.g., storage, data, applications, and even complete virtualized computing systems) in “the cloud,” without regard for the underlying physical systems (or locations of those systems) used to provide the computing resources.

Typically, cloud computing resources are provided to a user on a pay-per-use basis, where users are charged only for the computing resources actually used (e.g., an amount of storage space consumed by a user or a number of virtualized systems instantiated by the user). A user can access any of the resources that reside in the cloud at any time, and from anywhere across the Internet. In context of the present invention, a user may access applications (e.g., calendaring system) or related data available in the cloud. For example, the location aware calendaring system engine could execute on a computing system in the cloud. In such a case, the location aware calendaring system could maintain spatial and non-spatial data at a storage location in the cloud. Doing so allows a user to access this information from any computing system attached to a network connected to the cloud (e.g., the Internet).

The flowchart and block diagrams in the Figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order or out of order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

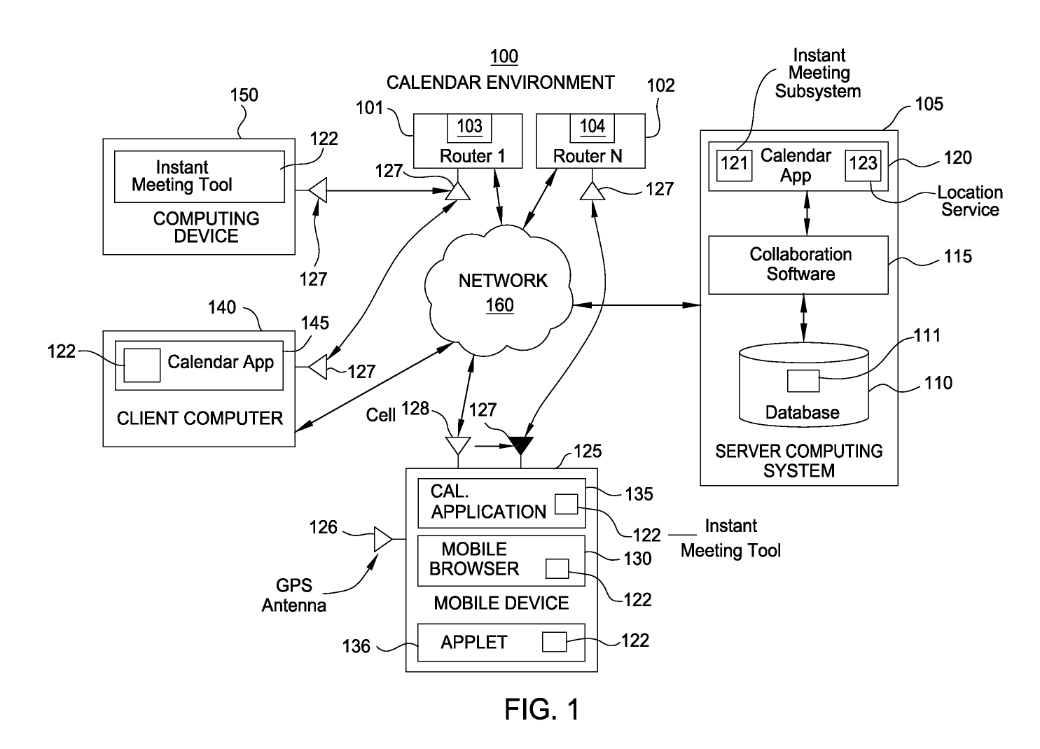

FIG. 1 illustrates a calendaring environment 100 on a network 160 in which one or more embodiments of the present invention may be implemented. Connected to the network 160 is a server 105. As shown, server 105 and routers 101 and 102 are connected to a network 160. Server 105 has collaboration software 115 and a database 110. The collaboration software 115 has a calendar application 120 with a subsystem component for an instant meeting 121 and a location service 123. The collaboration software 115 has data 111 which is stored in the database 110. In one embodiment of the invention, floor plans and router information is stored in the database 110. In another embodiment, an instant meeting 121 is created and stores the data 111 in the database 110. The server 105 may exist as a physical machine, a virtual machine, IaaS or the like. The collaboration software 115 may provide email, voice, social, calendar 120, address book, tasks and other enterprise applications.

Router₁ 101 has a unique service set identifier (SSID) 103 and routerₙ 102 has a different SSID 104. The routers 101 and 102 also have a antenna 127 providing wireless connections to the network 160. The antenna 127 provides wireless connections for mobile device 125, client computer 140, and computing device 150.

Mobile device 125 has a GPS antenna 126, a cell antenna 128, and an antenna 127. A calendaring application 135, mobile browser 130, and applet 136 are provided on the Mobile device 125. An instant meeting tool 122 may exist as a subsystem of the calendaring application 135, an applet 136, or as a web enabled client accessible from the mobile browser 130. In one embodiment, an instant meeting is created from an instant meeting tool 122 by selecting an applet 136 on the mobile device 125.

The client computer 140 and the computing device 150 both have an antenna 127 for wireless connections from routers 101 and 102 to the network 160. The client computer 140 has a calendar application 145. The calendar application 145 has an instant meeting tool 122 as part of its subsystem. In one embodiment, client computer 140 creates a meeting request with the instant meeting tool 122. The meeting request is forwarded to computing device 150.

In one embodiment, a meeting organizer selects the instant meeting tool 122 from the calendar application 145 on client computer 140. In response, the calendar application 120, on the server 105, provides a list of meeting locations to the meeting organizer. The meeting organizer sends out an instant meeting notice with a selected meeting location determined from the location service 123. The calendar application 120 sends the meeting notice to an attendee's mobile device 125. The mobile device 125 displays a route determined from the location service 123 to the meeting location in a mobile browser 130.

The meeting notice is received by a computing device 150, e.g., a tablet, phone, etc. The instant meeting tool 122 can either organize an instant meeting or receive a meeting notice. In one embodiment a map accompanies the meeting notice, which displays the current location of computing device 150 and a route to the meeting location determined from the location service 123.

All connecting devices have an antenna 127. Examples of a connecting device may be the computing device 150, or the mobile device 125. The calendar application 120 has a location service 123 which measures the communication signal strength between the antenna 127 and the router₁ 101, and routerₙ 102, to determine a location within a building for the devices attached to the antenna 127. Router₁ 101 broadcasts a unique service set identifier (SSID) 103 which is received by the antenna 127. The Received Signal Strength Indication (RSSI) of the SSID 103 may be used to indicate distance between the antenna 127 and router₁ 101. A measure of the RSSI is computed for each router SSID within range of the antenna 127. The three routers allow the location service 123 to determine a location for the computing device 150 and the mobile device 125. Knowledge of the location for these devices assist in the selection of a close and convenient meeting room location as well as determining the route to the meeting location on a provided map.

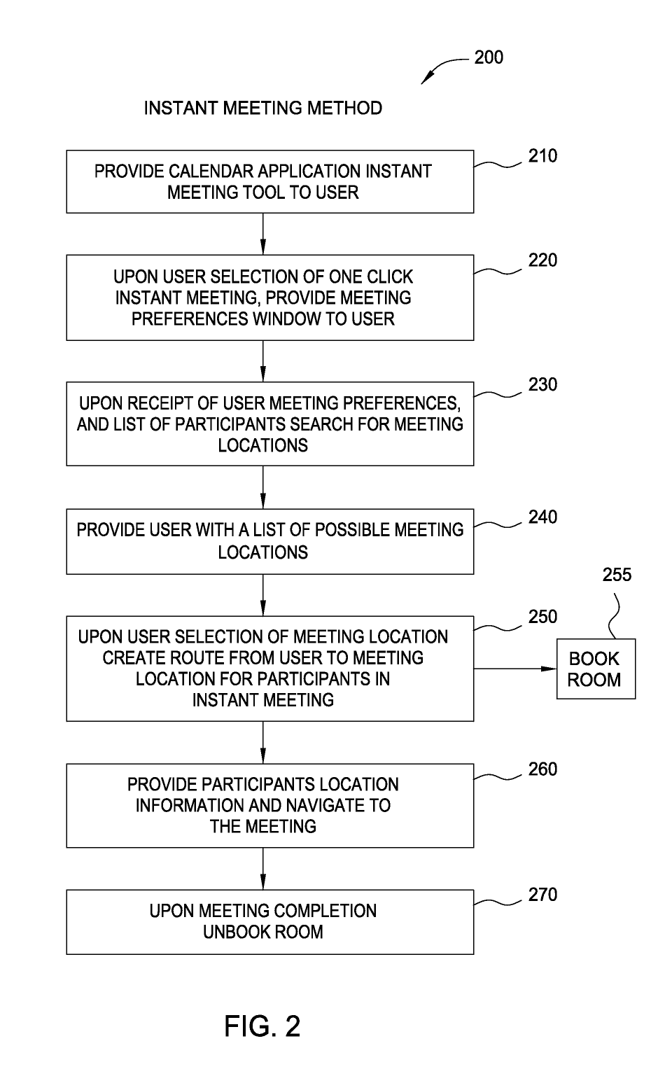

FIG. 2 illustrates a method 200 for scheduling an instant meeting, according to one embodiment. As shown, the method 200 begins at step 210, a user accesses an instant meeting tool. As noted, the instant meeting tool may provide a client server model approach with a calendar application managing connections to a database containing location and user information. For example, a client device may execute a thin client where configured to send requests to a server for processing and receive responses rendered on the mobile device. As another example a desktop application may execute on a desktop to receive and process an instant meeting request.

In step 220, a user requests the location aware calendar client schedule an instant meeting. The user may also specify preferences for the request. For example, the user may specify meeting location information, required resources, available meeting times, or a variety of other conditions. After specifying any meeting preferences, the preferences are provided to the location aware calendaring application.

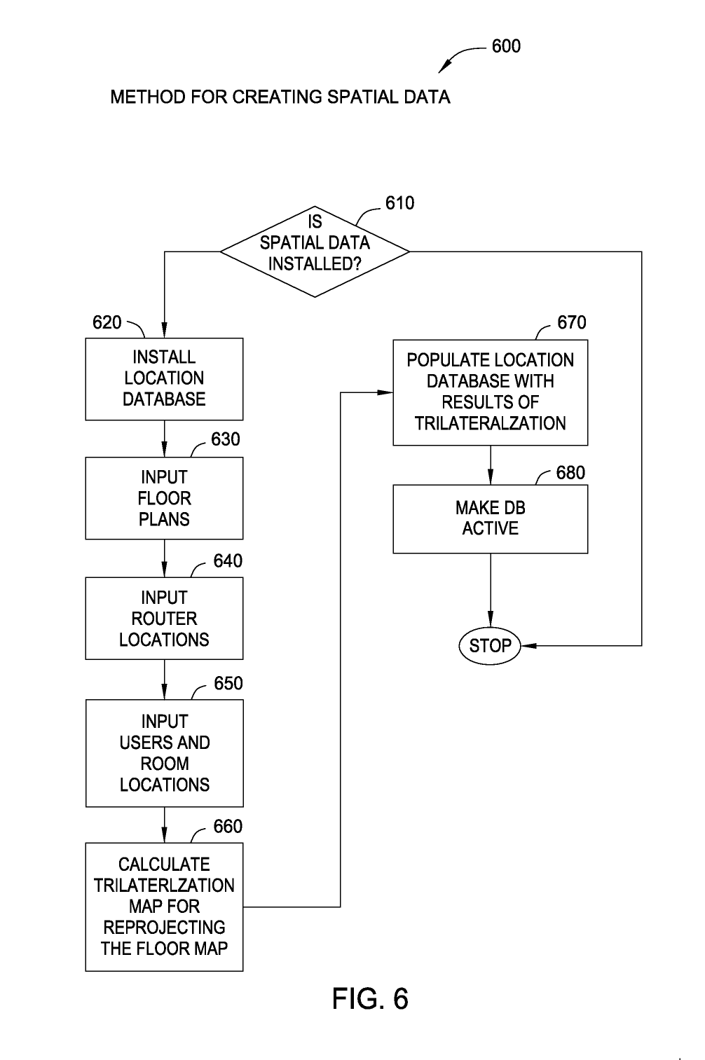

At step 230, the location aware calendaring application receives the user generated instant meeting preferences. The location aware calendaring application uses this information to identify a set of potential meeting room locations. Meeting rooms are selected based on an algorithm which may use the availability during the requested time slot, the proximity to invited attendees, the available of room resources, or any number of other provided criteria in the selected preferences or that may be appropriate in a particular case. The ability to determine the proximity of invited attendees requires spatial awareness in the calendaring application. The calendaring application determines the spatial relationship among these features by registering them in a common coordinate system. The registered coordinate system is created by the RSSI measurement data for individual know router locations. When a device receives RSSI data, the device can provide this information to the calendaring application to determine a location for the device. That is, the distance a device is away from the multiple routers can be used to predict a coordinate location. For instance, a computing device receiving RSSI information from 3 different routers would know how far away each router is and use this information to trilateralize its position from the known router locations. By knowing the locations for the routers and the distance a device is away from the routers (i.e. RSSI), a location can be determined for the device by generating a circle around each router of a magnitude equivalent to the RSSI data for that router. The position where all the RSSI “circles” overlap is indicative of the location of the device. The more RSSI information received from additional known locations, the more certain a position can be determined. A detail discussion begins with FIG. 6 for how the calendaring system detects the location of the individual attendee and the creation of the spatial data.

At step 240, the location aware calendaring application provides meeting room locations to the meeting organizer. The meeting organizer then selects one of the supplied meeting room locations from the set. The selection may be performed interactively via a mapping tool, by a location address book, or by specifying a name for a meeting room. The meeting organizer may alter or otherwise change the suggestions for the meeting room location provided by the location aware calendaring application.

At step 250, the meeting organizer selects a meeting location for the instant meeting. The location aware calendaring application uses computer software services for locating a person or device. Such a service is referred to as a location service. The location aware calendaring application determines a current location for each meeting attendee. For example, the location of an attendee may be obtained by the location services. Or an attendee's location may be determined from appointments in the attendee's calendar. Alternatively, if the location service is unable to provide an attendee's location, then a default location, as discussed later, may be identified. Either way, the location service generates a route to the provided meeting location for each attendee. Alternatively, if no location is available, an attendee may be notified of a meeting without being provided a route to that meeting. At step 255, the calendaring application also books the meeting room for the selected time slot. Booking of the meeting room ensures scheduling conflicts do not arise for the use of the room by more than one meeting organizer.

In one embodiment, the location aware calendaring application provides the meeting organizer and attendees the location information for an instant meeting (step 260). Attendees are provided a route from their current location to the meeting location on a georeferenced map. With location services, updates to an attendee's current location can be provided for the route map. After identifying a user location, finding a route to the destination meeting room may be determined by an A* algorithm (or other suitable routing algorithm). In this manner, an attendee may see where he or she is along the route to the meeting location. The attendee may use this information to provide up to date knowledge of the distance and time required to navigate through a building to an unknown location. This limits the chances of an attendee getting lost on the way to a meeting and also provides the feedback mechanism for an attendee to get back on track after deviating from the route on the way to a meeting.

In step 270, once a meeting has completed, the location aware calendaring application clears the booking of the meeting room. The calendaring application may use the scheduled time for the meeting to determine when a meeting has finished. In one embodiment the room is booked on the time preferences chosen when the instant meeting was made. In another embodiment, a meeting organizer may clear the booking of the meeting room through the calendaring application. In an augmented embodiment, the location aware calendaring application may monitor the location of attendees to determine when a meeting room has become available for other meetings (e.g., based on the presence of a wi-fi connected device geo-located based on the RSSI measurements of multiple wi-fi access points). After querying the current location for attendees, and determining all attendees have left a meeting room, the location aware calendaring application clears the booking of the meeting room and makes it available for meetings.

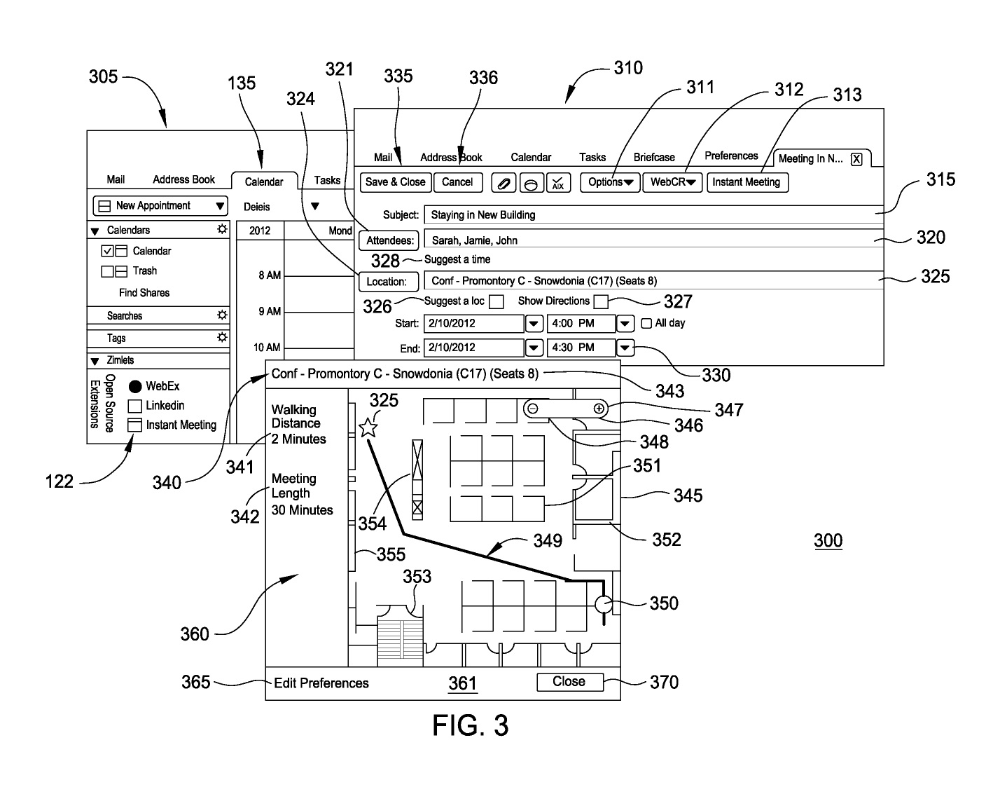

FIG. 3 illustrates an example graphical user interface 300 for generating an instant meeting in a calendaring application 135, according to certain embodiments of the present invention. The calendaring application 135 is a subsystem of a collaboration suite client 305. The collaboration suite client 305 may offer access to generating an instant meeting through an applet, instant meeting tool 122 or through the tab for the calendaring application 135.

The collaboration suite client maintains a page of meeting settings 310 for displaying information and preferences relating to a meeting. The preferences may include a subject 315, attendees 320, and a meeting location 325. The meeting location 325 can be selected from a location address book 324 or the collaboration suite client can provide suggested location 326 or time 328. The list of attendees 320 can also be populated from a personal address book 321. The meeting settings 310 also dates and times 330 to be selected as well as a link to directions 327, to save and close 335 or cancel 336 the meeting settings 310. Additional options 311 are available for selecting additionally required equipment such as whiteboards or projectors. Once the meeting preferences have been set, a meeting organizer may send the meeting out using instant meeting 313 or a web conferencing resource 312.

The link for the directions 327 brings up a map window 340. The map window 340 has a map 345, the meeting location bar 343, an information bar 360, and an action bar 361. The information bar 360 provides information such as walking distance 341 and meeting length 342. The action bar 361 allows a user to edit 365 the display preferences and to close 370 the map window 340. The map 345 has map display tool 346. In addition to other map navigation capabilities, the map display tool 346 may include the capabilities to zoom in 347 and zoom out 348. The map 345 displays a route 349. The route 349 is from the recipient/user current location 350 and the meeting location 325. The route 349 traverses the map 345 cognizant of walls 354, stairs 353, cubicles 351, offices 352, meeting rooms 355, and other tangible interior features.

The instant meeting tool 122 incorporates data from the user's current location 350, user settings, and inputs to book a meeting room. The instant meeting tool 122 allows access to a location aware calendaring application 120 and the data to determine a meeting room for all attendees. The meeting settings 310 display a list of preferences for the meeting. The meeting organizer selects attendees 320 from the personal address book 321. A meeting organizer is just a user who wishes to schedule a meeting. Likewise an attendee is just a user who will participate in the meeting.

In another embodiment, the meeting organizer selects additional options 311 to ensure a requirement is available, such as a projector, and to provide additional criteria for a meeting room selection. The meeting organizer selects the link for the suggested location 326 to populate the meeting location 325. Alternatively, the meeting organizer may select the location address book 324 to find a different meeting room.

A user may select an instant meeting 122 from the collaboration suite client 305. The meeting organizer selects a particular meeting location 325 from the location address book 324. Once a user submits the meeting request, the location service calculates a route 349 to the meeting for the attendees 320. The location aware calendaring application transmits a map 345 and corresponding route 349 with the meeting request to each attendee. The collaboration suite client 305 may also allow the user to adjust their instant meeting settings and receive navigation directions for meetings in their calendar.

An attendee, from the list of attendees 320, receives the meeting request and selects to view the directions 327, presented in map window 340. Illustratively, the meeting location bar 343 displays the meeting room name, number, and size. The recipient zooms in 347 on the map 345 to examine the route 349 to the meeting location 325. As the recipient navigates through the building, the map 345 is updated with a recipient's current location 350 and walking distance 341 to the meeting location 325.

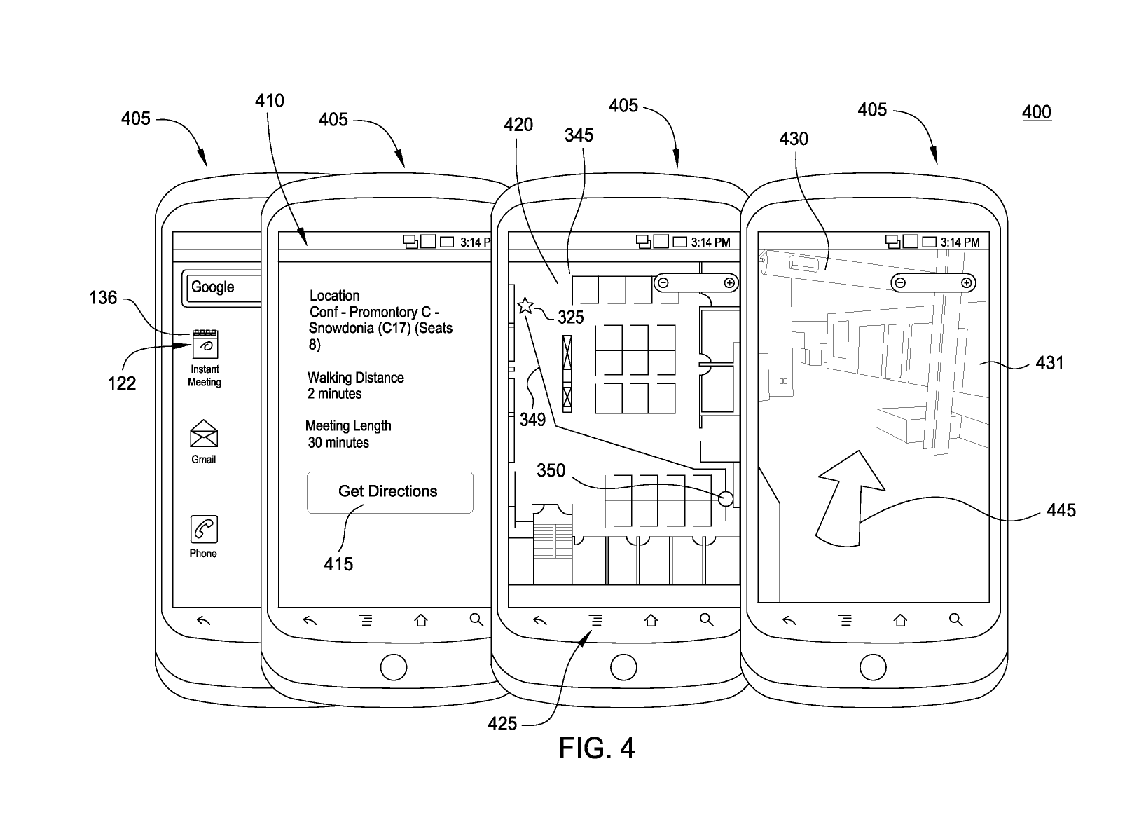

FIG. 4 illustrates an example mobile graphical user interface 400 for generating an instant meeting in a mobile device 405, according to certain embodiments of the present invention. In this example, an applet 136 is used to generate the instant meeting 122. Clicking the icon for the instant meeting 122 generates a view 410 of the meeting room on the mobile device 405. The view 410 provides a link to get directions 415. The link to get directions 415 opens a meeting map page 420 on the mobile device 405. The context menu 425 on this page provides an augmented reality view 431 on the mobile device 405. The augmented reality view 431 utilizes a camera display overlaid with a direction arrow 445 to direct a user along the route 349 to a planned location.

In one embodiment, a user selects the icon for an instant meeting 122 on a mobile device 405. The view 410 is displayed on the mobile device 405, providing the meeting room location and a link to directions 415. The user selects the link to view the directions 415 on meeting map page 420. The user's current location 350 is displayed on the map 345. The map 345 provides a route to the meeting location 325. The user navigates along the route 349 with the user's current location 350 updating in the map 345 along the way.

In another embodiment, the user can access an augmented reality view 431 from the context menu 425. The augmented reality view 431 provides a view from a camera as seen if the device was held upright in front of the user. As shown, a direction arrow 445 points towards the meeting location 325. The augmented reality view 431 shows the perspective of the user's current location 350. The user may efficiently navigate to the meeting location 325 with the direction arrow 445 visually superimposed in the user's field of view.

The mobile device 405 may provide the same functionality as the applet 136 through a web client connection to the collaboration software 155 via an interface similar to that shown in FIG. 3. The web user interface may be similar to FIG. 3 and support the ability to edit the meeting location 325 preferences and other preferences as shown in the meeting settings 310. With one click on the instant meeting 122 the nearest room is booked and a meeting map page 420 is provided. Users can also get directions to any meeting using the link in the view 410.

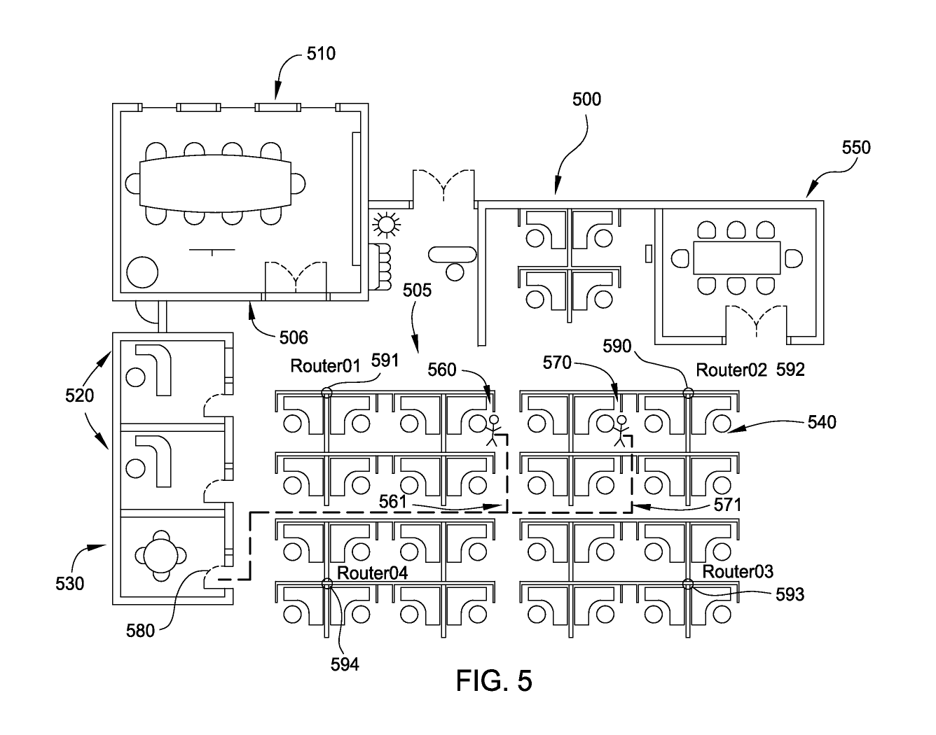

FIG. 5 illustrates an example map of a floor of an office building 500, according to certain embodiments of the present invention. The office building 500 has interior walls 506 and hallways 505. The interior walls 506 and hallways 505 define the interior spaces. From the hallways 505 there is access offices 520, cubicles 540, meeting room 530, large conference room 510, and a small conference room 550. Office building 500 also has routers 590. The routers 590 are individual designated as router01 591, router02 592, router03 593, and router04 594. The office building 500 has two example employees, employee01 560 and employee02 570.

In one embodiment an employee01 560 elects to create an instant meeting request for employee02 570. Employee01 560 uses the instant meeting tool 122 to book the meeting room 530 with 1-click which incorporates current location data from employee01 560 and employee02 570 using wireless signals from the routers 590. Route01 561 to the meeting location 580 is generated by the location services for employee01 560. Additionally, a route02 572 to the meeting location 580 is generated by the location services for employee02 570. Employee01 560 and employee02 570 are now able to quickly navigate from their respective cubicles to the meeting location 580. In another embodiment, employee01 560 selects additional attendees, or additional meeting room requirements, and the server selects a small conference room 550 for the instant meeting.

The examples of FIG. 5 rely on spatial data to navigate to a meeting location. FIG. 6 depicts a method 600 for creating the spatial data for the map, according to certain embodiments of the invention. The spatial data for map is updated over time. Examples include the addition of a new building to a campus, the remodeling of an existing office building, or the initial setup of the collaboration software 115.

In step 610, the collaboration software 115 determines if spatial data is available for a given location. If spatial data is unavailable, the spatial database may have to be installed in step 620. Otherwise, in step 630, an administrator, or analyst, inputs floor plans for a location, such as the office building 500 in FIG. 5, into the spatial database. The floor plans may be engineering plans or designs. The floor plans may be provided in an existing software format or as an image file. Along with the floor plans, locations of the existing wireless routers 101, 102 are stored in the spatial database in step 640. Default (Home) user locations may also be stored in the database. The default location for a user may be used when wireless is not available or if the user chooses to disable active location features. Additionally, room designations may also be updated. The location of the meeting rooms, offices or cubicles, as well as places of interest, such as lavatories, enhances the usability of the spatial data.

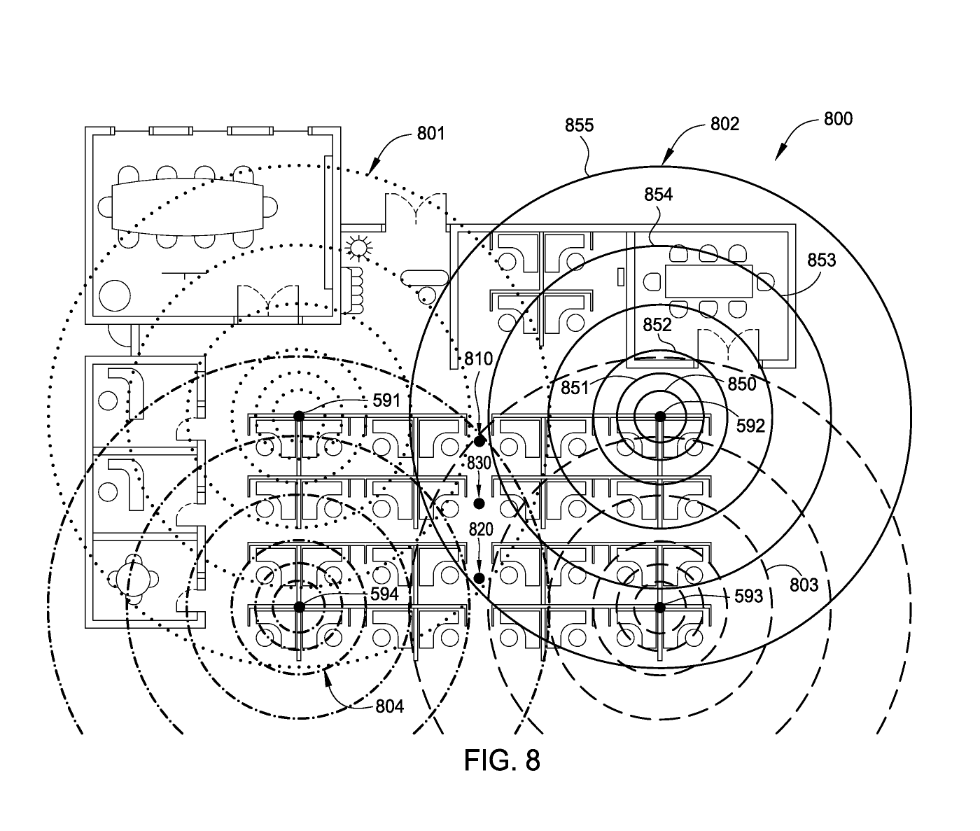

Given multiple routers in an office building, one way to determine a location in the office building is to use trilateration. Trilateration is a technique for determining absolute or relative positions using the geometry of spheres, circles or triangles via their overlap or proximity. (See FIG. 8.) In the case of locating a user, the location services are used to determine the overlap of “circular” RSSI coverage areas from each wireless routers to estimate a user's position.

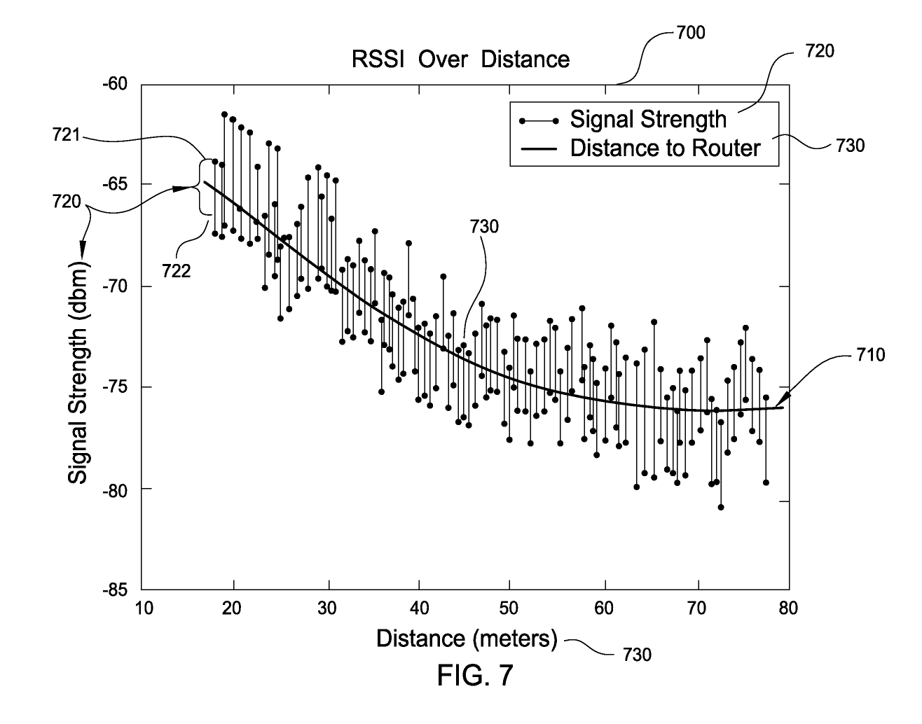

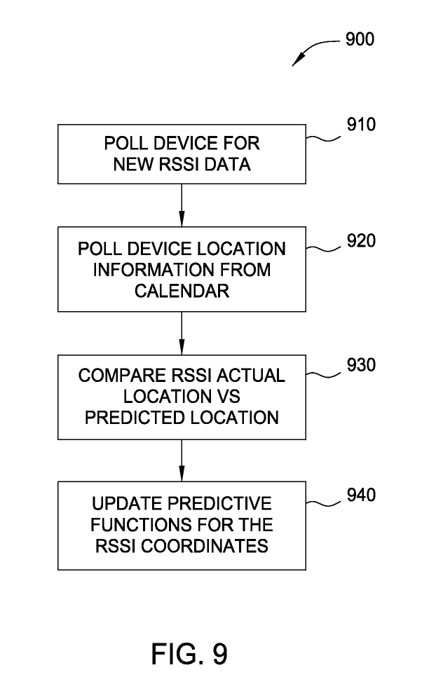

In step 660A trilateration map is created with spatial indexes. The spatial indexes are populated with the predicted signal strength of each router as a coordinate value. An algorithm calculates the Received Signal Strength Indication (RSSI) decay over distance for each router. An example of the signal decay graph 700 for a single router is shown in FIG. 7. Ideally, it is known that the calculated signal strength 720 for a given distance 730 can be represented by curve 710. However, as shown with FIG. 7 the relationship is not discrete and signal strength 720 has upper limits 721 and lower limits 722 in practicality. As previously mentioned, the RSSI information might be affected by many unforeseen and varying factors like the amount of moisture in the air, temperature, the building structure, etc. To address this issue, machine learning techniques may be used to improve the position accuracy of the RSSI coordinate data. Neural networks, a technique used for machine learning, is used to predict the position of a given device based on an input set of RSSI strengths. Training the neural network based on known locations for RSSI readings for multiple routers allows the location of a user (based on connected device) to be used to accurately predict the current location, despite the expected fluctuations or variations in signal strength. The details for providing improved positional accuracy for the RSSI coordinate data with neural networks is discussed below in FIG. 9. At step 670, an algorithm projects the floor map with the RSSI coordinate data and loads the data into the spatial database. The spatial coordinates are populated with the RSSI information for each router and used to project the spatial database into the local router RSSI coordinate system using the router locations as anchor points for the transformation. In step 680 the spatial database is made available for use by the calendaring application.

A device receiving wireless communication may use the RSSI information associated with each router in the office building 500 to provide coordinate information for the device. FIG. 8 shows an example of this RSSI information overlaid on the office building 500 in FIG. 5. As shown, router01 591 has an example RSSI shown at discrete signal strength intervals 801. Router02 592 has an example RSSI shown at discrete signal strength intervals 802. Router03 593 has an example RSSI shown at discrete signal strength intervals 803. And router04 594 has an example RSSI shown at discrete signal strength intervals 801. To further clarify, the example signal strength interval 802 is broken down to 6 rings. The line of the inner ring 850 is indicative of constant signal strength. Along this entire ring, the calculated signal strength may be −60 dBm. At the first ring interval 851, the calculated signal strength may be −65 dBm. As the distance increases from the router02 592, the second ring interval 852 may have a signal strength of −70 dBm, the third ring interval 853 may have a signal strength of −75 dBm, the fourth ring interval 854 may have a signal strength of −80 dBm, and the last (fifth) ring interval 855 may have a signal strength of −85 dBm.

In one embodiment, a location service utilizes the intersection of signal strength interval 801, signal strength interval 802, signal strength interval 803, and signal strength interval 804 to predict location 810. As a users traverses from location 810 through the office building 500 to location 820, the RSSI data for the routers 590 change along the path 830 to location 820. Location of fixed features, such as interior walls 506 and cubicles 540, can likewise be added to and spatially annotated in the database.

As previously discussed, the calculated signal strength 720 is subject to the variation seen by the upper limits 721 and the lower limits 722 as seen in FIG. 7. The variation may result from a number of factors, the least of which may include building composition or radio interference. This information changes the signal strength intervals 801-804 shown in FIG. 8. Under actual conditions, the shape of the rings will be unique for its environment and may become irregular in shape or spaced inconsistently. FIG. 9 provides a method 900 for building and training a neural network from the RSSI data, according to certain embodiments of the present invention. The method 900 is utilized to improve the spatial accuracy of the existing spatial data.

A neural networks based approach compensates for the fluctuations in the RSSIs. There are two steps in this approach. The first step is training. Two functions x=f′ (RSSI s) and y=f′ (RSSI s) based on the known set of x, y coordinates with corresponding RSSIs are computed. The functions f′ and f′ are the approximations of the real functions fₓ and f_{y} based on the known data. The second step is to deduce a user's location based on the current RSSI from the visible routers. A separate neural network is used for each axis.

The neural network is trained with the data developed from the trilateration of the routers RSSI information. The computed RSSI information from the visible routers at different locations is passed to a neural network, which, in turn, adjusts to represent the functions fₓ, f_{y} as close as possible. After training, the neural network can predict a user's location based on a set of RSSI signal strength measurements. The neural network learns how the signal strengths from multiple routers may vary and, based on the input set of signals, can predict current location more accurately then just using fixed ranges. Devices are polled for new RSSI router information in step 910. The coordinate data is captured and placed in the spatial database along with the location information. Each location has RSSI information associated with a SSID and represents an axis in the local coordinate system.

At step 920, the calendar application polls devices when a location is known for the device. The location of a conference room can be ascertained by using the calendar information from a user, who is scheduled to attend a meeting at a conference room. The RSSI may be measured and recorded while a user is (at least presumably) in the conference room attending a meeting. Additionally, location information may be obtained by sampling RSSI at a set of specified points throughout a floor plan for the purpose of training the spatial database.

The actual RSSI values are supplied to the neural network, which determines a predicted location of the mobile device (step 930). Actual RSSI information may be subject to temporal influences. That is, the signals from a conference room vary and as they vary, in correlated ways, the neural network can learn. The neural network is trained with examples of the signal strength (RSSI) for a known location. The neural network starts out with a best approximation, but based on how far off the answers are, adjustments are made to the predictive functions to provide more correct answers over time. Once trained, the network is given current signal strength information and then predicts a current location. That is, the network functions receive from a wireless device the actual measurements of the RSSI strengths for multiple routers and uses this to determine (or predict) a current prediction. In step 940, the predictive functions for in the RSSI coordinate data is updated. The training can be done continuously to fine tune itself. This way the spatial data is continuously refined and improved. Thus, the spatial data may provide more reliable location results.

The various embodiments described herein may employ various computer-implemented operations involving data stored in computer systems. For example, these operations may require physical manipulation of physical quantities—usually, though not necessarily, these quantities may take the form of electrical or magnetic signals, where they or representations of them are capable of being stored, transferred, combined, compared, or otherwise manipulated. Further, such manipulations are often referred to in terms, such as producing, identifying, determining, or comparing. Any operations described herein that form part of one or more embodiments of the invention may be useful machine operations. In addition, one or more embodiments of the invention also relate to a device or an apparatus for performing these operations. The apparatus may be specially constructed for specific required purposes, or it may be a general purpose computer selectively activated or configured by a computer program stored in the computer. In particular, various general purpose machines may be used with computer programs written in accordance with the teachings herein, or it may be more convenient to construct a more specialized apparatus to perform the required operations.

The various embodiments described herein may be practiced with other computer system configurations including hand-held devices, microprocessor systems, microprocessor-based or programmable consumer electronics, minicomputers, mainframe computers, and the like.

For employees that schedule several meetings a week, which is not unusual, this solution may save each employee considerable time each week. When accounting for number of employees in an organization and the number of weeks in a year, the time savings for a large organization may be significant. Booking impromptu meeting rooms and navigating to meeting rooms are only two of the many benefits of location-aware calendaring. Other benefits that could be supported with this feature include:
Easier booking of all meeting rooms even when traveling to remote offices;
Recommending multiple rooms when attendees are in different locations over a set distance;
Suggesting time zones that accommodate all attendees;
Suggesting rooms that minimize travel distance for all attendees;
Meeting reminders timed by travel distance e.g. 5 minute warning for a meeting nearby, 20 minute warning for meetings that require longer travel;
Improved conflict predictors for attendees who have to travel between meetings; and
Coworkers sharing exact location to facilitate face to face collaboration.

Although one or more embodiments have been described herein in some detail for clarity of understanding, it should be recognized that certain changes and modifications may be made without departing from the spirit of the invention.

The various embodiments described herein may employ various computer-implemented operations involving data stored in computer systems. For example, these operations may require physical manipulation of physical quantities—usually, though not necessarily, these quantities may take the form of electrical or magnetic signals, where they or representations of them are capable of being stored, transferred, combined, compared, or otherwise manipulated. Further, such manipulations are often referred to in terms, such as producing, identifying, determining, or comparing. Any operations described herein that form part of one or more embodiments of the invention may be useful machine operations. In addition, one or more embodiments of the invention also relate to a device or an apparatus for performing these operations. The apparatus may be specially constructed for specific required purposes, or it may be a general purpose computer selectively activated or configured by a computer program stored in the computer. In particular, various general purpose machines may be used with computer programs written in accordance with the teachings herein, or it may be more convenient to construct a more specialized apparatus to perform the required operations.

The various embodiments described herein may be practiced with other computer system configurations including hand-held devices, microprocessor systems, microprocessor-based or programmable consumer electronics, minicomputers, mainframe computers, and the like.

One or more embodiments of the present invention may be implemented as one or more computer programs or as one or more computer program modules embodied in one or more computer readable media. The term computer readable medium refers to any data storage device that can store data which can thereafter be input to a computer system—computer readable media may be based on any existing or subsequently developed technology for embodying computer programs in a manner that enables them to be read by a computer. Examples of a computer readable medium include a hard drive, network attached storage (NAS), read-only memory, random-access memory (e.g., a flash memory device), a CD (Compact Discs)—CD-ROM, a CD-R, or a CD-RW, a DVD (Digital Versatile Disc), a magnetic tape, and other optical and non-optical data storage devices. The computer readable medium can also be distributed over a network coupled computer system so that the computer readable code is stored and executed in a distributed fashion.

Although one or more embodiments of the present invention have been described in some detail for clarity of understanding, it will be apparent that certain changes and modifications may be made within the scope of the claims. Accordingly, the described embodiments are to be considered as illustrative and not restrictive, and the scope of the claims is not to be limited to details given herein, but may be modified within the scope and equivalents of the claims. In the claims, elements and/or steps do not imply any particular order of operation, unless explicitly stated in the claims.

Virtualization systems in accordance with the various embodiments, may be implemented as hosted embodiments, non-hosted embodiments or as embodiments that tend to blur distinctions between the two, are all envisioned. Furthermore, various virtualization operations may be wholly or partially implemented in hardware. For example, a hardware implementation may employ a look-up table for modification of storage access requests to secure non-disk data.

Many variations, modifications, additions, and improvements are possible, regardless the degree of virtualization. The virtualization software can therefore include components of a host, console, or guest operating system that performs virtualization functions. Plural instances may be provided for components, operations or structures described herein as a single instance. Finally, boundaries between various components, operations and data stores are somewhat arbitrary, and particular operations are illustrated in the context of specific illustrative configurations. Other allocations of functionality are envisioned and may fall within the scope of the invention(s). In general, structures and functionality presented as separate components in exemplary configurations may be implemented as a combined structure or component. Similarly, structures and functionality presented as a single component may be implemented as separate components. These and other variations, modifications, additions, and improvements may fall within the scope of the appended claim(s).

We claim:

1. A method for scheduling a meeting, the method comprising:
receiving a meeting request from a meeting initiator interacting with a device, wherein the meeting request identifies at least a first meeting attendee;
determining a location of the meeting initiator based on wireless signal strength information of the device, wherein the wireless signal strength information is a received signal strength indicator for a wireless router signal measured at the device and a neural network, using the wireless signal strength information, provides the determined location of the meeting attendee;
determining a location of the first meeting attendee; and
determining a meeting location based on the meeting request and at least the determined location of the meeting initiator and the determined location of the meeting attendee.

2. The method of claim 1, further comprising:
determining a route to the meeting location for the meeting initiator based on the location of the meeting initiator and the meeting location; and
transmitting to the meeting initiator a first notice that includes the route to the meeting location for the meeting initiator.

3. The method of claim 2, further comprising:
determining a route to the meeting location for the meeting attendee based on the location of the meeting attendee and the meeting location; and
transmitting to the meeting attendee a second notice that includes the route to the meeting location for the meeting attendee.

4. The method of claim 2, wherein the location of the meeting attendee is determined based on the wireless signal strength information.

5. The method of claim 2, wherein the location of the meeting attendee is determined based on a location of the meeting attendee maintained in a database.

6. The method of claim 3, further comprising:
determining an updated location of the meeting initiator and an updated location of the meeting attendee, wherein the updated location of the meeting initiator and the updated location of the meeting attendee are based on the wireless signal strength information; and
updating the route for the meeting initiator and the route for the meeting attendee based on the updated location of the meeting initiator and the updated location of the meeting attendee.

7. The method of claim 6, wherein the route for the meeting initiator and the route for the meeting attendee are displayed on a map, and the map is an augmented reality view provided by a real-time video with a direction indicator pointing to the meeting location overlaid on the real-time video.

8. The method of claim 1, wherein the location of the meeting initiator is determined to be a default location if the wireless signal strength information is unavailable.

9. A non-transitory computer-readable storage medium comprising program instructions which, when executed on a computing device, cause the computing device to perform a method for scheduling a meeting, said method comprising:
receiving a meeting request from a meeting initiator interacting with a device, wherein the meeting request identifies at least a meeting attendee;
determining a location of the meeting initiator based on wireless signal strength information;
determining a location of the meeting attendee;
determining a meeting location based on the meeting request and at least the determined location of the meeting initiator and the determined location of the meeting attendee;
determining a route to the meeting location for the meeting initiator based on the location of the meeting initiator and the meeting location;
transmitting to the meeting initiator a first notice that includes the route to the meeting location for the meeting initiator;
determining a route to the meeting location for the meeting attendee based on the location of the meeting attendee and the meeting location; and
transmitting to the meeting attendee a second notice that includes the route to the meeting location for the meeting attendee.

10. The non-transitory computer-readable storage medium of claim 9, wherein the method further comprises:
determining an updated location of the meeting initiator and an updated location of the meeting attendee, wherein the updated location of the meeting initiator and the updated location of the meeting attendee are based on the wireless signal strength information; and
updating the route for the meeting initiator and the route for the meeting attendee based on the updated location of the meeting initiator and the updated location of the meeting attendee.

11. The non-transitory computer-readable storage medium of claim 9, wherein the first notice and the second notice includes a display of the route for the meeting initiator and the route of the meeting attendee on a map and the map is an augmented reality view provided by a real-time video with a direction indicator pointing to the meeting location overlaid on the real-time video.

12. The non-transitory computer-readable storage medium of claim 9, wherein the location of the meeting initiator is determined to be a default location if the wireless signal strength information is unavailable.

13. A system, comprising:
a memory storing an application program; and
a processor which, when executing the application program, is configured to perform an operation for one-click scheduling of a meeting in a location aware calendaring system, the operation comprising:
receiving a meeting request from a meeting initiator interacting with a device, wherein the meeting request identifies at least a meeting attendee,
determining a location of the meeting initiator based on wireless signal strength information, wherein the wireless signal strength information is a received signal strength indicator for a wireless router signal measured at the device and a neural network, using the wireless signal strength information, provides the determined location of the meeting attendee,
determining a location of the meeting attendee, and
determining a meeting location based on the meeting request and at least the location of the meeting initiator and the location of the meeting attendee.

14. The system of claim 13, wherein the operation further comprises:
determining a route to the meeting location for the meeting initiator based on the location for the meeting initiator and the meeting location;
transmitting to the meeting initiator a first notice that includes the route to the meeting location for the meeting initiator;
determining a route to the meeting location for the meeting attendee based on the location of the meeting attendee and the meeting location; and
transmitting to the meeting attendee, a second notice that includes the route to the meeting location for the meeting attendee.

15. The system of claim 14 wherein the operation further comprises:
determining an updated location of the meeting initiator and an updated location of the meeting attendee, wherein the updated location of the meeting initiator and the updated location of the meeting attendee are based on the wireless signal strength information; and
updating the route for the meeting initiator and the route for the meeting attendee based on the updated location of the meeting initiator and the updated location of the meeting attendee.

16. The system of claim 15, wherein the route for the meeting initiator and the route for the meeting attendee are displayed on a map, and the map is an augmented reality view provided by a real-time video with a direction indicator pointing to the meeting location overlaid on the real-time video.

17. The system of claim 13, wherein the location of the meeting initiator is determined to be a default location if the wireless signal strength information is unavailable.
